(19) United States
(12) Patent Application Publication
(10) Pub. No.: US 2021/0089885 A1
(43) Pub. Date: Mar. 25, 2021

(54) TRAINING DEVICE AND TRAINING METHOD

(71) Applicant: Kioxia Corporation, Minato-ku (JP)

(72) Inventors: Daisuke MIYASHITA, Kawasaki (JP); Jun DEGUCHI, Kawasaki (JP); Asuka MAKI, Kawasaki (JP); Fumihiko TACHIBANA, Yokohama (JP); Shinichi SASAKI, Ota (JP); Kengo NAKATA, Kawasaki (JP)

(73) Assignee: Kioxia Corporation, Minato-ku (JP)

(21) Appl. No.: 16/811,137

(22) Filed: Mar. 6, 2020

(30) Foreign Application Priority Data
Sep. 19, 2019 (JP) 2019-170877

(51) Int. Cl. G06N 3/08; G06N 3/04; G06N 3/063

(52) U.S. Cl. CPC G06N 3/08; G06N 3/063; G06N 3/04

(57) ABSTRACT

According to one embodiment, a training device includes a first memory, a second memory, and a processing circuit. The first memory is a memory accessible at a higher speed than the second memory. The training device executes a training process of a machine learning model using a stochastic gradient descent method. The processing circuit stores a first output produced by the process of a first layer in the second memory, and stores a second output produced by the process of a second layer, in a forward process of the training process. The processing circuit updates a parameter of the second layer based on the second output stored in the first memory, reads the first output stored in the second memory, and updates a parameter of the first layer based on the read first output, in a backward process of the training process.

### CROSS-REFERENCE TO RELATED APPLICATIONS

This application is based upon and claims the benefit of priority from Japanese Patent Application No. 2019-170877, filed Sep. 19, 2019; the entire contents of which are incorporated herein by reference.

### FIELD

Embodiments described herein relate generally to a training device and a training method.

### BACKGROUND

In the related art, a technology for training a machine learning model by using a processor such as a graphics processing unit (GPU) has been disclosed.

However, a large-scale storage capacity is required in training of a large-scale machine learning model.

### BRIEF DESCRIPTION OF THE DRAWINGS

FIG. 1 is a block diagram illustrating an example of a configuration of a training device according to a first embodiment;

FIG. 2 is a diagram for explaining an outline of a training process of a neural network in the training device according to the first embodiment;

FIG. 3 is a flowchart illustrating an example of the training process of the neural network which is executed by the training device according to the first embodiment;

FIG. 4 is a diagram for explaining of storing of an activation in a NAND memory in the training device according to the first embodiment;

FIG. 5 is a flowchart illustrating an example of a backward process in a training process of a neural network which is executed by a training device according to a second embodiment; and

FIG. 6 is a diagram for explaining a change of a calculation order in the training process according to the second embodiment.

### DETAILED DESCRIPTION

In general, according to one embodiment, there is provided a training device that executes a training process of a machine learning model having a plurality of intermediate layers including at least a first layer and a second layer, and the training process includes a stochastic gradient descent method. The training device includes a first memory, a second memory, and a processing circuit. The first memory is a memory accessible at a higher speed than the second memory. The processing circuit is capable of accessing the first memory and the second memory. In a forward process of the training process, the processing circuit executes the process of the first layer using a first input and stores a first output generated by the process of the first layer in the second memory. Then the processing circuit executes the process of the second layer using the first output and stores a second output generated by the process of the second layer in the first memory. In a backward process of the training process, the processing circuit updates a parameter of the second layer based on the second output stored in the first memory, reads the first output stored in the second memory, and updates a parameter of the first layer based on the read first output.

Exemplary embodiments of a training device and a training method will be explained below in detail with reference to the accompanying drawings. A present invention is not limited to the following embodiments.

### First Embodiment

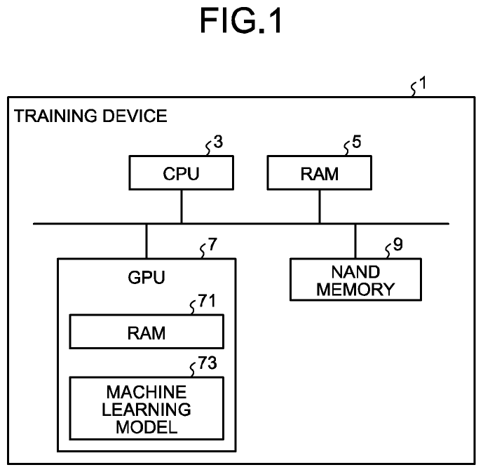

FIG. 1 is a block diagram illustrating an example of a configuration of a training device 1 according to a present embodiment. As illustrated in FIG. 1, the training device 1 includes a central processing unit (CPU) 3, a random access memory (RAM) 5, a GPU 7, and a NAND memory 9. The CPU 3, the RAM 5, the GPU 7, and the NAND memory 9 are connected to be able to communicate with each other via, for example, a bus. The GPU 7 includes a RAM 71 and a machine learning model 73.

The CPU 3 controls operations of the training device 1. For example, the CPU 3 executes a training program of the machine learning model 73 according to a training program which is read out from the NAND memory 9 or the RAM 5. The GPU 7 includes a RAM 71. For example, the GPU 7 executes a training process of the machine learning model 73 according to a training program which is read out from the NAND memory 9 and is loaded into the RAM 71. Model information related to the machine learning model 73, such as the number of layers, the number of parameters, and parameter values of the machine learning model 73, are stored in the NAND memory 9. Training data and various programs related to operations of the training device 1, such as the training schedule, and the training program of the machine learning model 73 are stored in the NAND memory 9. A static RAM (SRAM) or a synchronous dynamic RAM (SDRAM) can be appropriately used as the RAM 5 and the RAM 71. The RAM 71 is a memory having a read latency shorter than a read latency of the NAND memory 9. That is, a time required for the GPU 7 to read data with a certain size from the RAM 71 is shorter than a time required for the GPU 7 to read data with the identical certain size from the NAND memory 9.

Logic circuits such as a programmable logic device (PLD) such as a field-programmable gate array (FPGA) and an application specific integrated circuit (ASIC) configured to realize the training process according to the embodiment may be used instead of the GPU 7.

Storage devices such as other integrated circuit storage devices, a hard disk drive (HDD), and solid state drive (SSD) can be appropriately used in addition to the NAND memory 9. These storage devices may be used in place of the NAND memory 9.

Here, the GPU 7 is an example of a processing circuit. As the processing circuit, the CPU 3 may be used in addition to the GPU 7, or the CPU 3 may be used instead of the GPU 7. The RAM 71 is an example of a first memory. When the CPU 3 is used as the processing circuit, the RAM 5 may be used as the first memory. The NAND memory 9 is an example of a second memory. As the second memory, another memory such as the RAM 5 may be used in addition to the NAND memory 9, or another memory such as the RAM 5 may be used instead of the NAND memory 9. When the RAM 5 is used as the first memory, the RAM 71 of the GPU 7 may be used as the second memory.

It is assumed that the training data related to the machine learning model 73 according to the embodiment are a set of training samples expressed as (Xᵢ, Yᵢ) with respect to an input Xᵢ and a desired output (correct output or teacher data) Yᵢ for the input Xᵢ (i is an integer greater than or equal to 0). The training data are divided into a plurality of mini-batches, and are used for training. For example, when 100 images are used as one mini-batch, training data including one million images are divided into 10,000 mini-batches, and are used for training.

It is assumed that the machine learning model 73 according to the present embodiment is defined by a combination of a plurality of adjustable functions and parameters. The machine learning model 73 according to the present embodiment may be the any kind of combined function which is defined by the combination of any kinds of adjustable functions and parameters, but is at least a multilayer network model. In the present embodiment, an example in which the machine learning model 73 is a convolutional neural network (CNN) model will be described. However, the machine learning model 73 according to the present embodiment is not limited to the CNN, and may be a fully connected network. Hereinafter, the machine learning model 73 according to the present embodiment is simply referred to as a neural network.

The neural network may be a machine learning model that performs any inference. For example, the neural network may be a machine learning model that receives image data as an input and outputs a classification result of the image data, may be a machine learning model that realizes noise removal of the image data, or may be a machine learning model that performs speech recognition.

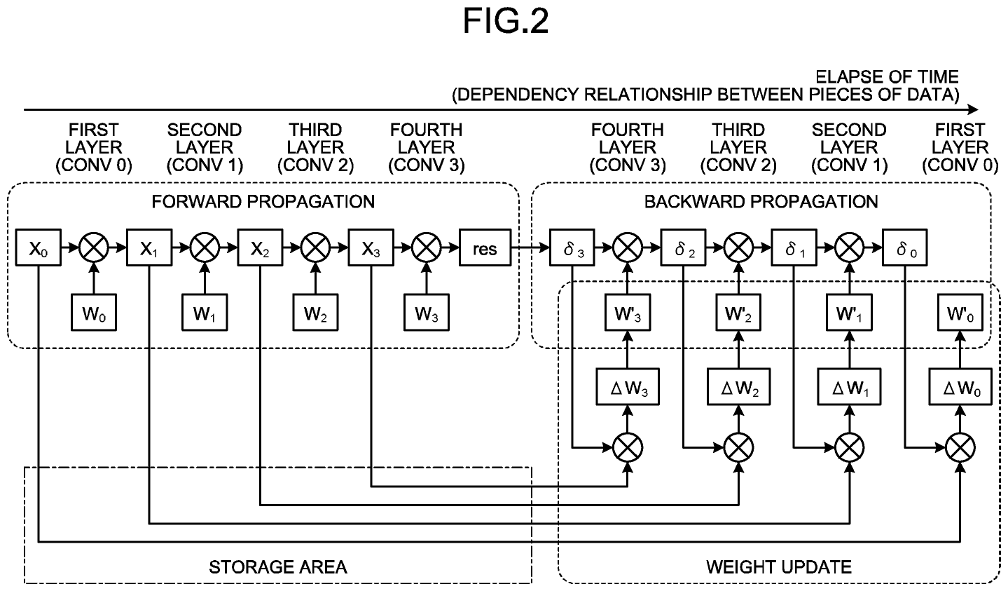

Here, an outline of training of the machine learning model 73 (neural network) according to the present embodiment will be described. FIG. 2 is a diagram for explaining the outline of a training process of the neural network in the training device 1 according to the present embodiment.

The neural network according to the present embodiment includes an input layer, a plurality of intermediate layers (at least two convolution layers), and an output layer. In FIG. 2, the input layer and the output layer are not illustrated, and a neural network including four convolution layers is illustrated. In the following description, a weight parameter of each layer of the neural network is simply referred to as a parameter (W). An input value or an output value of each layer is simply referred to as activation (X).

In the plurality of convolution layers, each node multiplies each input value from a node of the previous layer by a weighting factor (parameter: W) and accumulates the results. Then a normalization function and/or an activation function are applied to produce the output (activation: X). For example, batch normalization can be used as the normalization function used in each convolution layer, but the normalization function is not limited thereto, and other normalization functions may be used. For example, a rectified linear unit (ReLU) function can be used as the activation function used in each convolution layer, but the activation function is not limited thereto, and other activation functions such as sigmoid function or maxout function may be used. In the present embodiment, each convolution layer includes a normalization layer and an activation layer.

It is assumed that the machine learning model 73 according to the present embodiment is trained by using a stochastic gradient descent method (SGD). Specifically, in the training process of the machine learning model 73 according to the present embodiment, back-propagation is used for calculating gradient of the parameter. The training process includes a forward process and a backward process. These processes are executed for each mini-batch. A technology according to the present embodiment is not limited to mini-batch training, but can be applied to other training methods such as online training and batch training.

First, the forward process is performed. The forward process includes a process of receiving data as an input of the input layer of the neural network and performing calculation of all the intermediate layers of the neural network in forward order. The forward process is almost identical to a process called “inference” for actually executing image recognition which is executed after training is completed.

In the example illustrated in FIG. 2, an activation 0(X₀) is input to a first convolution layer (hereinafter, referred to as CONV0). Here, it is assumed that the activation 0(X₀) is an output of the input layer. It is assumed that nodes corresponding to input data are provided in the input layer. For example, when the input data are image data, the nodes corresponding to the number of pixels of the image data are provided in the input layer as nodes to which the image data are input. In the CONV0, a process is performed using the input activation 0(X₀) and a parameter (W₀) as described above. A result (output) of the CONV0 is an activation 1(X₁).

The activation 1(X₁) is input to the second convolution layer (hereinafter, referred to as CONV1). In the CONV1, a process is performed using the input activation 1(X₁) and a parameter (W₁). A result (output) of the CONV1 is an activation 2(X₂).

The activation 2(X₂) is input to a third convolution layer (hereinafter, referred to as CONV2). In the CONV2, a process is performed using the input activation 2(X₂) and a parameter (W₂). A result (output) of the CONV2 is an activation 3(X₃).

The activation 3(X₃) is input to a fourth convolution layer (hereinafter, referred to as CONV3). In the CONV3, a process is performed using the input activation 3(X₃) and a parameter (W₃). A result (output) of the CONV3 is output as an output (res) via the output layer. In the output layer, each node multiplies each input value from a node of a previous layer (CONV3) by a weighting factor, and outputs a value (res) obtained by applying the activation function to a sum of values obtained by multiplying the input values by the weighting factors. For example, a softmax function can be used as the activation function used in the output layer, but the activation function is not limited thereto, and other activation functions may be used.

A result (res) obtained by the forward process is compared with an expected output (teacher data: Yᵢ) of the neural network, and a difference between the result and the expected output is calculated as a loss (δ₃). For example, in a case of the image recognition, a cross-entropy error obtained by performing a softmax function on the output of the neural network is used as a loss.

Subsequently, the backward process is performed. The backward process is performed in order to obtain a gradient for each parameter of a loss (δ). Here, the gradient is a value indicating in which direction the parameter (W) of each convolution layer is to be changed in order to reduce the loss (δ) calculated in the forward process.

The loss (δ₃) obtained by the forward process is input to the CONV3 via the output layer. A gradient (ΔW₃) is calculated based on the loss (δ₃) and the activation 3(X₃) obtained by the forward process. A parameter (W′₃) updated by using the parameter (W₃) used in the forward process and the gradient (ΔW₃) is obtained. In the CONV3, the backward process is performed based on the input loss (δ₃) and the parameter (W₃). It is assumed that the result (output) of the backward process at CONV3 is a loss (δ₂).

The loss (δ₂) is input to the CONV2. A gradient (ΔW₂) is calculated based on the loss (δ₂) and the activation 2(X₂). A parameter (W′₂) updated by using the parameter (W₂) used in the forward process and the gradient (ΔW₂) is obtained. In the CONV2, the backward process is performed based on the input loss (δ₂) and the parameter (W₂). It is assumed that the result (output) of the backward process at CONV2 is the loss (δ₁).

The loss (δ₁) is input to the CONV1. A gradient (ΔW₁) is calculated based on the loss (δ₁) and the activation 1(X1). A parameter (W′₁) updated by using the parameter (W₁) used in the forward process and the gradient (ΔW₁) is obtained. In the CONV1, the backward process is performed based on the input loss (δ₁) and the parameter (W₁). It is assumed that the result (output) of the backward process at CONV1 is a loss (δ₀).

A gradient (ΔW₀) is calculated based on the loss (δ₀) and the activation 0(X₀). A parameter (W′₀) updated by using the parameter (W₀) used in the forward process and the gradient (ΔW₀) is obtained.

As stated above, in the backward process, new parameters (W′₃, W′₂, W′₁, and W′₀) are obtained by propagating the gradients in a reverse order for the plurality of convolution layers (CONV3, CONV2, CONV1, and CONV0) by using the loss (δ₃) obtained in the forward process as the input, calculating the gradients (ΔW₃, ΔW₂, ΔW₁, and ΔW₀) for the parameters (W₃, W₂, W₁, and W₀) , and updating the parameters (W₃, W₂, W₁, and W₀).

Here, a dependency relationship between the activations (X₀, X₁, X₂, and X₃) in the training process using the SGD is considered. As described above, in the forward process, the activations (X₀, X₁, X₂, and X₃) in the process for one mini-batch are generated in the order of the activation 0(X₀), the activation 1(X₁), the activation 2(X₇), and the activation 3(X₃), and are used in a process in the next layer and the backward process. In the backward process after the forward process, the activation 3(X₃), the activation 2(X₂), the activation 1(X₁), and the activation 0(X₀) are used in this order.

That is, all the activations (X) generated in the forward process need to be saved for use in the backward process. Most of a memory usage during training is a memory usage used for saving the activations (X). Therefore, as a scale of the neural network becomes larger, a larger memory capacity is required. The activation (X) generated earlier in the forward process is used later in the backward process. That is, the activation (X) generated earlier needs to be stored but is not read for a longer period of time.

In general, there is a demand for training a larger-scale neural network. The large memory capacity is required for training the large-scale neural network. A technology for training the neural network by using the GPU is also known. However, for example, there is an upper limit to the memory capacity of the SDRAM of the GPU from the viewpoint of cost. A semiconductor memory device such as the NAND memory can easily increase the memory capacity, but has a longer read and write latency. As the latency becomes longer, since a time required for access (read and write) increases, a training speed decreases. Thus, in the training using the GPU, the scale of the neural network that is able to be trained can be limited by the memory capacity of the SDRAM of the GPU.

Therefore, in the training device 1 and the training method according to the present embodiment, the large-scale neural network is trained by storing activations that are not read for a long period of time in another memory.

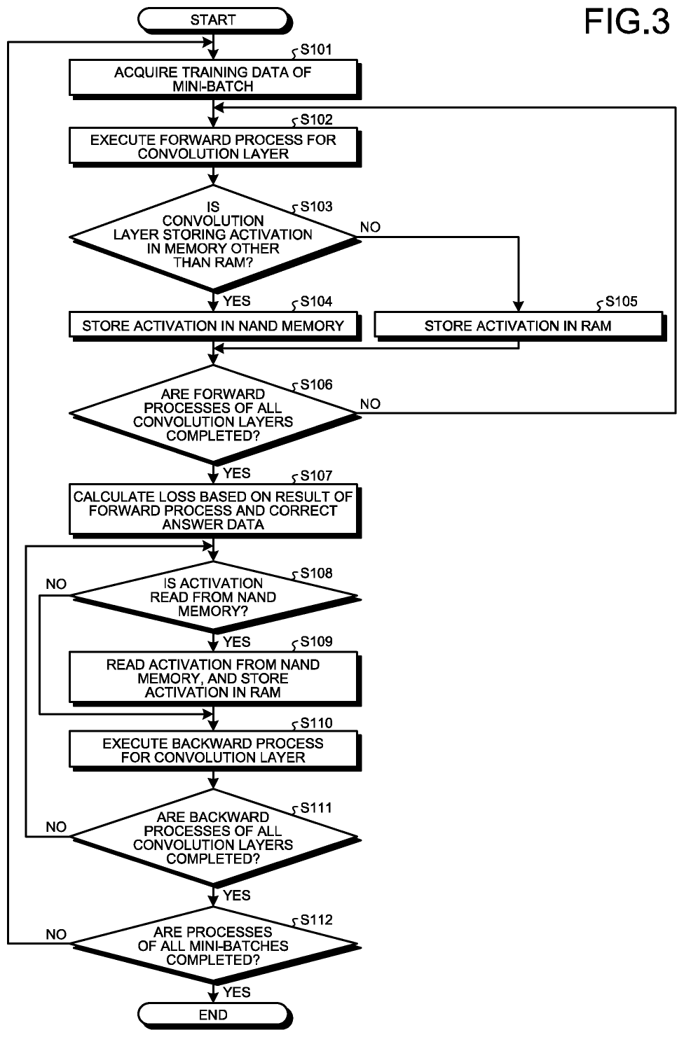

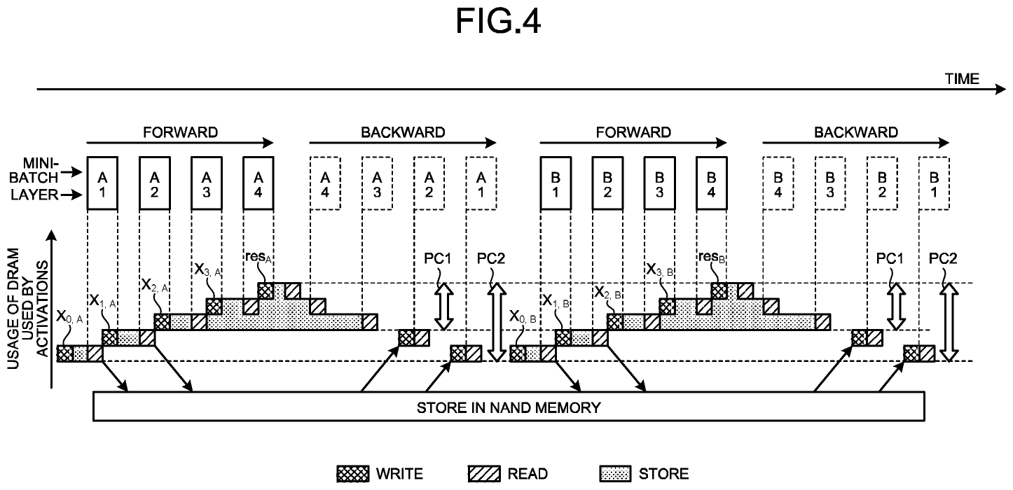

Hereinafter, an operation example of the training device 1 according to the present embodiment will be described with reference to the drawings. FIG. 3 is a flowchart illustrating an example of the training process of the neural network executed by the training device 1 according to the present embodiment. FIG. 4 is a diagram for describing a storage destination of the activations (X) in the training device 1 according to the present embodiment.

It is assumed that each determination in the flowchart illustrated in FIG. 3 is a branch of a process executed according to a schedule decided in advance by a program or a structure (array). Of course, a determination process may be executed by the CPU 3 or the GPU 7.

The GPU 7 acquires training data for a mini-batch A (S101), and starts a training process related to the mini-batch A. The GPU 7 inputs the training data to the input layer, and writes an activation (X_{0,A}) for the mini-batch A which is the output of the input layer in the RAM 71.

### Forward Process: Layer A1

Subsequent to S101, the GPU 7 executes the forward process for the first convolution layer (layer A1) of the mini-batch A (S102). Specifically, the GPU 7 reads an activation 0(X_{0,A}) stored in the RAM 71, inputs the read activation to the layer A1, acquires an activation 1(X_{1,A}) which is the output of the layer A1, and writes the acquired activation in the RAM 71. Since the layer A1 is a layer that stores the activation 0(X_{0,A}) in another memory other than RAM 71 (S103: Yes), the GPU 7 inputs the activation 0(X_{0,A}) to the layer A1, outputs the activation 0(X_{0,A}) to the NAND memory 9, and stores the activation 0(X_{0,A}) in the NAND memory 9 (S104). At this time, since the forward processes of all the convolution layers are not completed and the second convolution layer (layer A2) of the mini-batch A is present after the layer A1 (S106: No), the process returns to S102.

### Forward Process: Layer A2

The GPU 7 executes the forward process for the layer A2 (S102). Specifically, the GPU 7 reads the activation 1(X_{1,A}) stored in the RAM 71, inputs the read activation to the layer A2, acquires an activation 2(X_{2,A}) which is the output of the layer A2, and writes the acquired activation in the RAM 71. Since layer A2 is a layer that stores the activation 1(X_{1,A}) in another memory other than RAM 71 (S103: Yes), the GPU 7 inputs the activation 1(X_{1,A}) to the layer A2, outputs the activation 1(X_{1,A}) to the NAND memory 9, and stores the activation 1(X_{1,A}) in the NAND memory 9 (S104). At this time, since the forward processes of all the convolution layers are not completed and the third convolution layer (layer A3) of the mini-batch A is present after the layer A2 (S106: No), the process returns to S102.

### Forward Process: Layer A3

The GPU 7 executes the forward process for the layer A3 (S102). Specifically, the GPU 7 reads the activation 2(X_{2,A}) stored in the RAM 71, inputs the read activation to the layer A3, acquires an activation 3(X_{3,A}) that is the output of the layer A3, and writes the acquired activation in the RAM 71. Since the layer A3 is a layer that does not store the activation 2(X_{2,A}) in another memory other than the RAM 71 (S103: No), the GPU 7 does not store the activation 2(X_{2,A}) in the NAND memory 9, and continues to store this activation in the RAM 71 (S105). At this time, since the forward processes of all the convolution layers are not completed and the fourth convolution layer (layer A4) of the mini-batch A is present after the layer A3 (S106: No), the process returns to S102.

### Forward Process: Layer A4

The GPU 7 executes the forward process for the layer A4 (S102). Specifically, the GPU 7 reads the activation 3(X_{3,A}) stored in the RAM 71, inputs the read activation to the layer A4, acquires an output (res_{A}) of the forward process via the output layer, and writes the acquired output in the RAM71. Since the layer A4 is a layer that does not store the activation 3(X_{3,A}) in another memory other than the RAM 71 (S103: No), the GPU 7 does not save the activation 3(X_{3,A}) in the NAND memory 9, and continues to store this activation in the RAM 71 (S105). At this time, since the forward processes of all the convolution layers are completed (S106: Yes), the process proceeds to S107.

As described above, in the present embodiment, the activations (X) generated by performing the forward process are stored in the RAM 71 or the NAND memory 9. Specifically, when it is determined that a time until the activation (X) is used in the next backward process (first period) is sufficiently longer than the total time (second period) of a time required for writing the activation (X) in the NAND memory 9 and a time required for reading the activation (X) from the NAND memory 9, the activations (X) are stored in the NAND memory 9. As illustrated in FIG. 4, a peak usage (PC1) of the RAM71 used by the activations (X) when some activations (X_{0,A} and X_{1,A}) are stored in the NAND memory 9 (the present embodiment) is smaller than a peak usage (PC2) when all the activations (X) are stored in the RAM 71 (comparative example). That is, according to the technology according to the present embodiment, the usage of the RAM 71 used during training using the activations (X) can be reduced.

The determination mentioned herein means that a user such as a programmer follows instructions written in codes when the training process is programmed. That is, for example, the CPU 3 receives an input based on the program code created by the user such as the programmer, and determines whether or not each activation (X) is stored in the NAND memory 9. The user such as the programmer determines whether or not to store the activation (X) in the NAND memory 9 for each convolution layer, and inputs the determination result to the training device 1. That is, whether or not to store each activation (X) in the NAND memory 9 is set and described in advance in the training program for executing the training process. This determination is not limited to the determination performed by the user, and a compiler that compiles the training program may have a function of outputting an execution code for determining whether or not to store each activation (X) in the NAND memory 9. In this case, the compiler estimates a time until each activation (X) is read next based on the model information of the neural network such as the number of convolution layers in the neural network and the number of nodes in each convolution layer, and determines whether or not to store each activation (X) in the NAND memory 9 from a relationship between the estimated time (first period) and a time (second period) required for accessing the NAND memory 9. The model information and the time required for accessing the NAND memory 9 may be stored in advance in, for example, the NAND memory 9. The time required for accessing the NAND memory 9 may be measured by executing write and read operations. Various pieces of performance information such as an operation frequency of the GPU 7, a bandwidth with the RAM 71, and the number of channels may be taken into account in estimating the time until each activation (X) is read next.

Subsequent to S106, the GPU 7 calculates the loss (δ₃) based on the processing result (res_{A}) of the forward process for the mini-batch A and the correct answer data for the mini-batch A (S107), and writes the calculated loss (δ₃) in the RAM71.

The GPU 7 determines whether or not to read each activation (X) used in the backward process for each subsequent convolution layer from the NAND memory 9 (S108). When it is determined to be a reading timing (S108: Yes), the process proceeds to S109. The GPU 7 starts reading the activation (X) stored in the NAND memory 9, and stores the read activation (X) in the RAM 71. The process proceeds to S110. Meanwhile, when the activation is not read from the NAND memory 9 (S108: No), the process proceeds to S110.

A time required for reading data from the NAND memory 9 is longer than a time required for reading data from the RAM 71 (for example, SDRAM). Thus, in the determination of S108, it is determined to be a timing of starting reading depending on whether or not the reading is completed before the activation (X) is actually used in the calculation in the backward process.

Similar to the aforementioned determination of whether or not to store each activation (X) in the NAND memory 9, the timing of starting reading may be instructed by the code written by the user such as the programmer when the process is programmed, or may be determined by the function of the compiler that compiles the program. The function of the compiler may be a function of estimating a time until the activation stored in the NAND memory 9 is read next, calculating the timing of starting reading from a relationship between the estimated time and the time required for reading the activation from the NAND memory 9, and inserting a read start command at an appropriate position.

The reading of the data from the NAND memory 9 may mean that the data stored in the NAND memory 9 are moved to a location at which the calculation is performed, or may mean that the data are moved from the NAND memory 9 to the RAM 71 (for example, SDRAM). In a case where the data are moved to the RAM 71, the activation (X) is already stored in the RAM 71 when the backward process for the convolution layer is performed. Thus, as in a case where the data are not stored in the NAND memory 9, even when the data are stored in the NAND memory 9, the activation (X) may be read from the RAM 71 as usual, and may be processed.

### Backward Process: Layer A4

Here, the activation 3(X_{3,A}) used in the layer A4 is stored in the RAM 71 (S108: No), and the GPU 7 executes the backward process for the layer A4 (S110). Specifically, the GPU 7 reads the activation 3(X_{3,A}) and the loss (δ₃) stored in the RAM 71, calculates the gradient (ΔW₃), and updates the parameter (W₃). The GPU 7 acquires the loss (δ₂) output from the layer A4 according to the loss (δ₃) and the parameter (W₃), and writes the acquired loss in the RAM 71. At this time, since the backward processes of all the convolution layers are not completed and the layer A3 is present after the layer A4 (S111: No), the process returns to S108.

### Backward Process: Layer A3

Here, an activation 3(X_{2,A}) used in the layer A3 is stored in the RAM 71 (S108: No), and the GPU 7 executes the backward process for the layer A3 (S110). Specifically, the GPU 7 reads the activation 2(X_{2,A}) and the loss (δ₂) stored in the RAM 71, calculates the gradient (ΔW₂), and updates the parameter (W₂). The GPU 7 acquires the loss (δ₁) output from the layer A3 according to the loss (δ₂) and the parameter (W₂), and writes the acquired loss in the RAM 71. At this time, since the backward processes of all the convolution layers are not completed and the layer A2 is present after the layer A3 (S111: No), the process returns to S108.

### Backward Process: Layer A2

Here, an activation 3(X_{1,A}) used in the layer A2 is stored not in the RAM 71 but in the NAND memory 9 (S108: Yes). This activation 3(X_{1,A}) is read from the NAND memory 9, and is stored in the RAM 71 (S109). The GPU 7 executes the backward process for the layer A2 (S110). Here, it is assumed that the reading of the activation 1(X_{1,A}) stored in the NAND memory 9 is completed before the backward process for the layer A2 is started and the activation is stored in the RAM 71. For example, it is assumed that this reading is started during the backward process for the layer A4 or the layer A3 which is performed before the backward process for the layer A2. Specifically, the GPU 7 reads the activation 1(X_{1,A}) and the loss (δ₁) stored in the RAM 71, calculates the gradient (ΔW₁), and updates the parameter (W₁). The GPU 7 acquires the loss (δ₀) output from the layer A2 according to the loss (δ₁) and the parameter (W₁), and writes the acquired loss in the RAM 71. At this time, since the backward processes of all the convolution layers are not completed and the layer A1 is present after the layer A2 (S111: No), the process returns to S108.

### Backward Process: Layer A1

Here, an activation 3(X_{0,A}) used in the layer A1 is stored not in the RAM 71 but in the NAND memory 9 (S108: Yes). This activation 3(X_{0,A}) is read from the NAND memory 9, and is stored in the RAM 71 (S109). The GPU 7 executes the backward process for the layer A1 (S110). Here, it is assumed that the reading of the activation 0(X_{0,A}) stored in the NAND memory 9 is completed before a timing when the backward process for the layer A1 is started and the activation is stored in the RAM 71. For example, it is assumed that this reading is started during the backward process for the layer A4, the layer A3, or the layer A2 which is performed before the backward process for the layer A1. Specifically, the GPU 7 reads the activation 0(X_{0,A}) and the loss (δ₀) stored in the RAM 71, calculates the gradient (ΔW₀), and updates the parameter (W₀). At this time, since the backward processes for all the convolution layers are completed (S111: Yes), the process proceeds to S112.

When the training process is not completed for all the mini-batches (S112: No), the process returns to S101, and the processes of S101 to S112 are repeated for another mini-batch (for example, mini-batch B). When the training process is completed for all the mini-batches (S112: Yes), the process ends.

As stated above, in the training device 1 and the training method according to the present embodiment, the activation (X) generated earlier in the forward process is stored in the NAND memory 9 which is another memory other than the RAM 71 of the GPU 7, and the activation (X) generated later is stored in the RAM 71 of the GPU 7. Each activation may be stored in the RAM 71 when each activation is used next in the backward process, and does not need to be stored in the RAM 71 for a period of time during which each activation is not used. For example, since a period of time until the activation generated earlier such as the activation 0(X₀) is used next becomes longer, even though this activation is temporarily stored in the NAND memory 9 to which the time required for accessing, this long accessing time can fall within the period until this activation is used next. That is, in the training device 1 and the training method according to the present embodiment, since the large-capacity memory with a long read latency can be used without degrading the training speed, the large-scale neural network (machine learning model 73) can be trained.

In the training device 1 and the training method according to the present embodiment, the determination of whether or not the activation (X) is stored in the NAND memory 9 is performed before the training is performed by the user or the compiler, for example. That is, in the training device 1 and the training method according to the present embodiment, the activation (X) to be stored in the NAND memory 9 can be determined (scheduled) in advance according to the configuration of the machine learning model 73 (neural network). More specifically, the determination of whether or not to store the activation (X) in the NAND memory 9 is not a dynamic determination according to an actual memory usage during training, and a static determination according to a time required for accessing (writing and reading) of the NAND memory 9 and a use timing and a size of the activation (X). According to this configuration, the machine learning model 73 (neural network) can be trained without dynamically executing the determination process of whether or not to store the activation (X) in the NAND memory 9 during the training using the GPU. That is, according to the technology according to the present embodiment, the large-scale neural network (machine learning model 73) can be trained without decreasing the training speed due to the determination process. Of course, the dynamic determination according to the actual memory usage during training may be performed.

### Second Embodiment

In the first embodiment, the training device 1 that stores some of the activations (X) in the NAND memory 9 from the RAM 71 of the GPU 7 in the forward process and starts the reading of the activations (X) stored so as to be in time the backward process has been described. However, a time required for actually reading the activation from the NAND memory 9 may vary.

For example, an example in which the reading of the activation 1(X_{1,A}) used in the backward process of the layer A2 from the NAND memory 9 is delayed and the reading is not completed before the backward process of the layer A2 is started is illustrated. As stated above, when a memory with a long read latency such as the NAND memory 9 is used as the memory as the storage destination, there is a concern that the reading of the activation (X) from the NAND memory 9 will not be completed at a timing of starting the backward process. Although the backward process may be started after the reading of the activation (X) from the NAND memory 9 is completed, the training speed decreases by a wait for reading.

Therefore, in the training device 1 and the training method according to the second embodiment, when the wait for reading occurs, the forward process of the next mini-batch is started without waiting for the reading from the NAND memory 9.

As described above, in the training process of the neural network using the SGD, the gradient of the parameter (weight) is calculated for the first mini-batch, and the parameter (weight) is updated. Thereafter, the gradient of the parameter (weight) is calculated for the second mini-batch, and the parameter (weight) is updated. That is, in the training process of the neural network using the SGD, the parameters (weights) are sequentially updated for the divided mini-batches.

It is noted that the updated parameter (weight) for the first mini-batch is used when the second gradient is calculated. Therefore, when the gradient of the parameter of the second mini-batch is calculated before the updating of the parameter of the first mini-batch is completed, that is, when the calculation is performed by changing a calculation order, a result different from a result when the calculation order is not changed is obtained. However, even when the result changes due to a change in the calculation order for a certain mini-batch, although the number of epochs (number of mini-batches) to converge or complete training may increase, the trained neural network having the identical inference accuracy can be obtained. That is, in the present embodiment, by avoiding interruption of the training process due to the wait for reading from the NAND memory 9, it is possible to improve the training speed.

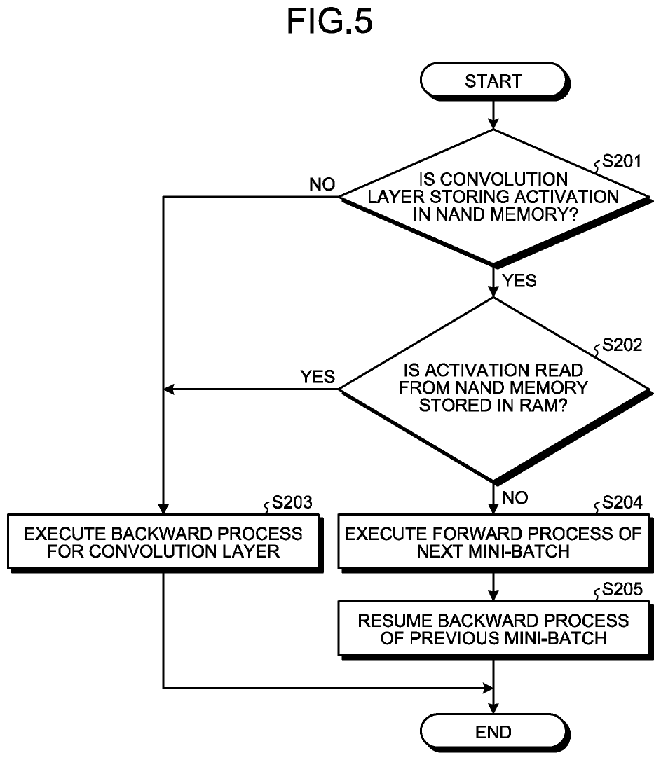

FIG. 5 is a flowchart illustrating an example of the backward process in the training process of the neural network which is executed by the training device 1 according to the second embodiment. The flowchart in FIG. 5 corresponds to S110 in the flowchart in FIG. 3.

When the convolution layer is not a convolution layer that stores the activation (X) in the NAND memory 9 in the forward process (S201: No), the GPU 7 executes the backward process for this convolution layer as in S110 of FIG. 3 (S203). When the convolution layer is a convolution layer that stores the activation (X) in the NAND memory 9 in the forward process (S201: Yes) and the activation (X) read from the NAND memory 9 is stored in the RAM 71 (S202: Yes), the GPU 7 executes the backward process for this convolution layer as in S110 of FIG. 3 (S203).

Meanwhile, when the convolution layer is a convolution layer that stores the activation (X) in the NAND memory 9 in the forward process (S201: Yes) and the activation (X) read from the NAND memory 9 is not stored in the RAM 71 (S202: No), the GPU 7 changes the processing order. Specifically, the GPU 7 interrupts the backward process of this convolution layer, and executes the forward process of the convolution layer of the next mini-batch (S204).

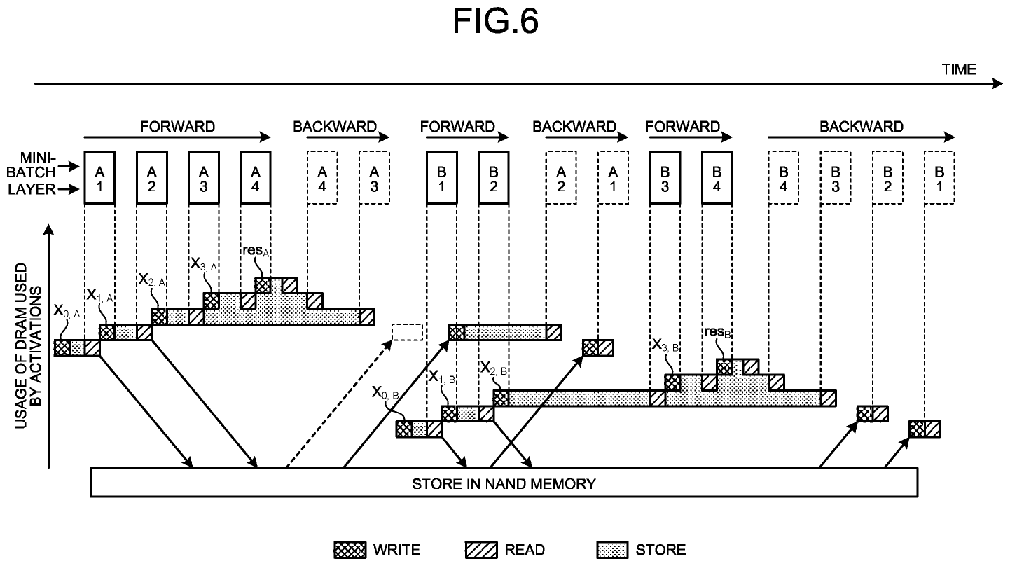

FIG. 6 is a diagram for describing the change of the calculation order in the training process according to the present embodiment. When the reading of the activation 1(X_{1,A}) from the NAND memory 9 is not completed before the backward process of the layer A2 is started, the GPU 7 suspends the backward process of the layer A2 and the layer A1. The GPU 7 executes the forward process of the first convolution layer (layer B1) of the mini-batch B and the second convolution layer (layer B2) of the mini-batch B.

After the calculation order is changed and the forward process (S204) of the convolution layer of the next mini-batch is executed, the GPU 7 resumes the process of the mini-batch A (S205). In the example illustrated in FIG. 6, the GPU 7 executes the backward process of the layer A2 by using the activation 1(X_{1,A}) which is read during the forward process of the layer B1 or the layer B2 and is stored in the RAM 71, and then executes the backward process of the layer A1. After the backward process of the layer A2 and the layer A1, the GPU 7 executes the forward process of the third convolution layer (layer B3) of the mini-batch B and the fourth convolution layer (layer B4) of the mini-batch B according to S102 in FIG. 3. Thereafter, the GPU 7 executes the backward process of the mini-batch B (S110 or S201 to S205 in FIG. 3).

In the example illustrated in FIG. 6, the training process for the mini-batch A and the training process for the mini-batch B are training processes for training the identical parameter (W) by using different pieces of training data. That is, the training process according to the present embodiment can be performed as distributed training including the training process for the mini-batch A and the training process for the mini-batch B.

The number of convolution layers for which the calculation order is changed may be one layer, may be a plurality of layers of three or more layers, or may be all the forward processes of the next mini-batch.

The number of convolution layers for which the calculation order is changed may be instructed by the code written by the user such as the programmer at a point of time when the process is programmed, or may be determined by the function of the compiler that compiles the program. The backward process of a previous mini-batch may be resumed upon the completion of the reading of the activation (X) waiting for reading. For example, when the forward process of the layer B1 is completed in the forward process of the mini-batch B performed after interruption, it may be determined whether or not the reading of the activation 1(X_{1,A}) for the layer A2 of the interrupted mini-batch A from the NAND memory 9 is completed. In this case, when the reading of the activation 1(X_{1,A}) from the NAND memory 9 is completed, the forward process of the mini-batch A may be resumed.

The convolution layer of the forward process of the next mini-batch for which the calculation order is changed may be any of the convolution layers that store the activation (X) in the NAND memory 9. In this case, even though the forward process of the next mini-batch is executed first, since the RAM 71 does not need to newly store the activation (X) of the next mini-batch, it is possible to suppress an increase in memory usage of the RAM 71 does not need to newly save the activation (X) of the next mini-batch along with the change of the calculation order.

The interrupted backward process may not be executed. That is, the flow of S205 may not be executed after S204. According to this configuration, even though the activation (X) stored in the NAND memory 9 cannot be read for some reason, it is possible to suppress a decrease in training speed until the processing time required until the process of one mini-batch is interrupted decreases.

As stated above, in the training device 1 and the training method according to the second embodiment, when the wait for reading occurs, the forward process of the next mini-batch is started without waiting for completing the reading from the NAND memory 9. According to this configuration, in addition to the effects obtained in the aforementioned embodiment, there is an effect that it is possible to suppress a deterioration (decrease) in training speed along with the wait for reading from the NAND memory 9.

In the training device 1 and the training method according to the first and second embodiments, it is possible to store the activation in another memory from the RAM 71. That is, the memory of the storage destination is not limited to the NAND memory 9, and various memories can be used.

In the aforementioned embodiment, the storing of the activation stored in the RAM 71 of the GPU 7 in the NAND memory 9 may be expressed as the movement of the activation stored in the RAM 71 to the NAND memory 9, and means that the activation stored in the RAM 71 is written in the NAND memory 9 and the activation is stored in the NAND memory 9. At this time, the activation stored in the NAND memory 9 may be completely deleted from the RAM 71, or an area where the activation is stored in the NAND memory 9 may be managed as an overwritable, that is, an available area. In any case, it is possible to increase the available memory capacity of the RAM 71 by storing the activation in the NAND memory 9.

According to at least one of the aforementioned embodiments, it is possible to provide the training device and the training method capable of training the large-scale machine learning model.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A training device configured to execute a training process of a machine learning model including a plurality of intermediate layers including at least a first layer and a second layer, the training process using a stochastic gradient descent method, the device comprising:
a first memory;
a second memory; and
a processing circuit that is capable of accessing the first memory and the second memory,
wherein the first memory is a memory accessible at a higher speed than the second memory, and
the processing circuit is configured to:
input a first output of the first layer corresponding to a first input to the second layer, store the first output in the second memory, and store a second output of the second layer corresponding to the first output in the first memory, in a forward process of the training process, and
update a parameter of the second layer based on the second output stored in the first memory, read the first output stored in the second memory, and update a parameter of the first layer based on the read first output, in a backward process of the training process.

2. The training device according to claim 1,
wherein the first memory is provided inside the processing circuit, and
the second memory is provided outside the processing circuit.

3. The training device according to claim 1,
wherein the machine learning model further includes an output layer following to the plurality of intermediate layers, and
an output of an intermediate layer which is closest to the output layer among the plurality of intermediate layers is not stored in the second memory.

4. The training device according to claim 1, wherein the processing circuit is further configured to determine an intermediate layer of which an output is to be stored in the second memory among the plurality of intermediate layers before the training process is started.

5. The training device according to claim 1, wherein the processing circuit is further configured to determine an intermediate layer of which an output is to be stored in the second memory among the plurality of intermediate layers based on a first period between a time when the output of the intermediate layer is used in the forward process and a time when the output is used in the backward process, and a second period necessary for the processing circuit to access the second memory for the output of the intermediate layer.

6. The training device according to claim 5, wherein the second period includes a total time of a time necessary for the processing circuit to write the output of the intermediate layer in the second memory and a time necessary for the processing circuit to read the output of the intermediate layer from the second memory.

7. The training device according to claim 1, wherein the processing circuit is further configured to start the forward process for next training data when the reading of the first output stored in the second memory is not in time in the backward process.

8. The training device according to claim 7, wherein the forward process for the next training data is executed until the reading of the first output stored in the second memory is completed or as much processes as the number of intermediate layers determined before the training process is started are completed.

9. The training device according to claim 7, wherein the forward process for the next training data is a process for an intermediate layer which is determined to be stored in the second memory before the training process is started, among the plurality of intermediate layers.

10. The training device according to claim 1, wherein the second memory is a memory having a capacity larger than a capacity of the first memory.

11. The training device according to claim 1, wherein the first memory is an SDRAM.

12. The training device according to claim 1, wherein the second memory is a NAND memory.

13. The training device according to claim 1, wherein the processing circuit includes a GPU or a CPU.

14. The training device according to claim 1, wherein the processing circuit is further configured to read the first output stored in the second memory, store the read first output in the first memory, and update the parameter of the first layer based on the first output stored, in the first memory in the backward process.

15. The training device according to claim 1, wherein
the processing circuit is further configured to
input the second output to a third layer of one layer after the second layer, and store a third output of the third layer corresponding to the second output in the first memory, in the forward process, and
update a parameter of the third layer based on the third output stored in the first memory, in the backward process.

16. A training method executed in a training device that includes a first memory and a second memory, and configured to execute a training process of a machine learning model including a plurality of intermediate layers including at least a first layer and a second layer, the training process using a stochastic gradient descent method, the first memory being a memory accessible at a higher speed than the second memory,
the training method comprising:
inputting a first output of the first layer corresponding to a first input to the second layer, storing the first output in the second memory, and storing a second output of the second layer corresponding to the first output in the first memory, in a forward process of the training process, and
updating a parameter of the second layer based on the second output stored in the first memory, reading the first output stored in the second memory, and updating a parameter of the first layer based on the read first output, in a backward process of the training process.

17. The training method according to claim 16,
wherein the machine learning model further includes an output layer following to the plurality of intermediate layers, and
an output of an intermediate layer which is closest to the output layer among the plurality of intermediate layers is not stored in the second memory.

18. The training method according to claim 16, further comprising determining an intermediate layer of which an output is to be stored in the second memory among the plurality of intermediate layers before the training process is started.

19. The training method according to claim 16, further comprising determining an intermediate layer of which an output is to be stored in the second memory among the plurality of intermediate layers based on a first period between a time when the output of the intermediate layer is used in the forward process and a time when the output is used in the backward process, and a second period necessary for the processing circuit to access the second memory for the output of the intermediate layer.

20. The training method according to claim 16, further comprising starting the forward process for next training data when the reading of the first output stored in the second memory is not used in time in the backward process.
